(19) United States
(12) Patent Application Publication
(10) Pub. No.: US 2012/0188519 A1
(43) Pub. Date: Jul. 26, 2012

(54) PROJECTION AND DISPLAY SYSTEM

(75) Inventors: Stephen J. Willett, Saint Paul, MN (US); Martin B. Wolk, Woodbury, MN (US); Terry L. Smith, Roseville, MN (US); Roy A. Auerbach, Dallas, TX (US); Michael A. Haase, Saint Paul, MN (US); Steven G. Saxe, Santa Rosa, CA (US); Tommie W. Kelley, Shoreview, MN (US)

(73) Assignee: 3m Innovative Properties Company, Saint Paul, MN (US)

(21) Appl. No.: 13/392,635

(22) PCT Filed: Aug. 30, 2010
(86) PCT No.: PCT/US10/47077

§ 371 Date: Apr. 10, 2012

Related U.S. Application Data
(60) Provisional application No. 61/238,290, filed on Aug. 31, 2009.

(51) Int. Cl. G03B 21/14

(52) U.S. Cl. 353/31

(57) ABSTRACT

A projection system and a display that incorporates the projection system are provided. The projection system includes at least one electroluminescent device that emits a first wavelength of light, at least one semiconductor multilayer stack that downconverts the first wavelength of light to a second wavelength of light, and a scanning optical element that transmits the light along a scanned direction. The electroluminescent device can be part of an array of electroluminescent devices, and can be monolithic. The semiconductor multilayer stack can be part of an array of semiconductor multilayer stacks, and can also be monolithic. The scanning optical element can be positioned to scan the electroluminescent device across the semiconductor multilayer stack, or it can be positioned to scan the downconverted light after it has left the semiconductor multilayer stack.

### BACKGROUND

Illumination systems are used in many different applications, including projection display systems, backlights for liquid crystal displays and the like. Projection systems typically use one or more conventional white light sources, such as high pressure mercury lamps. The white light beam is usually split into three primary colors, red, green and blue, and is directed to respective image forming spatial light modulators to produce an image for each primary color. The resulting primary-color image beams are combined and projected onto a projection screen for viewing. Conventional white light sources are generally bulky, inefficient in emitting one or more primary colors, difficult to integrate, and tend to result in increased size and power consumption in optical systems that employ them.

More recently, light emitting diodes (LEDs) have been considered as an alternative to conventional white light sources. LEDs have the potential to provide the brightness and operational lifetime that would compete with conventional light sources. Current LEDs, however, especially green emitting LEDs, are relatively inefficient.

Microprojection is a display technology that encompasses emissive devices with a very small form factor. A representative example of microprojection technology is a recently announced microprojection engine from 3M Company based on a Liquid Crystal on Silicon (LCoS) spatial light modulator (SLM), a light emitting diode (LED) illuminator, and a compact polarizing beam splitter.

Smaller, brighter, more power efficient full-color microprojectors for portable and embedded applications such as mobile phones and digital still cameras are desired. Such microprojectors preferably have the capability of projecting a still or moving image. The trend in projector development tends towards engines having a higher pixel count, higher brightness, smaller volume, and lower power consumption.

### SUMMARY

In one aspect, the present disclosure provides a projection system that includes at least one first linear array having electroluminescent devices emitting light at a first wavelength, and a second linear array that includes at least one first semiconductor multilayer stack. The first semiconductor multilayer stack is disposed to receive the emitted first wavelength light and downconvert at least a first portion of the received light to an emitted second wavelength light. The projection system further includes a scanning optical element disposed to transmit at least the emitted second wavelength light along a scanned direction.

In another aspect, the present disclosure provides a display that includes a projection system and a projection screen. The projection system includes a first linear array having electroluminescent devices emitting light at a first wavelength, and a second linear array that includes at least one first semiconductor multilayer stack. The first semiconductor multilayer stack is disposed to receive the emitted first wavelength light and downconvert at least a first portion of the received light to an emitted second wavelength light. The projection system further includes a scanning optical element disposed to transmit at least the emitted second wavelength light along a scanned direction. The projection screen is disposed to intercept the scanned light.

In yet another aspect, the present disclosure provides a projection system that includes a first linear array having electroluminescent devices emitting light at a first wavelength, and a second array of receiving elements including at least one first semiconductor multilayer stack. Each of the first semiconductor multilayer stacks is disposed to receive the emitted first wavelength light and downconvert at least a first portion of the received light to an emitted second wavelength light. The projection system further includes a scanning optical element disposed between the first linear array and the second array. The scanning optical element is capable of sequentially directing the emitted first wavelength light from each of the electroluminescent devices toward one of a plurality of receiving elements of the second array.

In yet another aspect, the present disclosure provides a display that includes a projection system and a projection screen. The projection system includes a first linear array having electroluminescent devices emitting light at a first wavelength, and a second array of receiving elements including at least one first semiconductor multilayer stack. Each of the first semiconductor multilayer stacks is disposed to receive the emitted first wavelength light and downconvert at least a first portion of the received light to an emitted second wavelength light. The projection system further includes a scanning optical element disposed between the first linear array and the second array. The scanning optical element is capable of sequentially directing the emitted first wavelength light from each of the electroluminescent devices toward one of a plurality of receiving elements of the second array. The projection screen is disposed to intercept the scanned light.

In yet another aspect, the present disclosure provides a projection system that includes

an electroluminescent device emitting light at a first wavelength and a semiconductor multilayer stack. The semiconductor multilayer stack is disposed to receive the emitted first wavelength light and downconvert at least a first portion of the received light to an emitted second wavelength light. The projection system further includes a scanning optical element disposed to receive the emitted second wavelength light, and transmit the emitted second wavelength light along a scanned direction.

In yet another aspect, the present disclosure provides a display that includes a projection system and a projection screen. The projection system includes an electroluminescent device emitting light at a first wavelength and a semiconductor multilayer stack. The semiconductor multilayer stack is disposed to receive the emitted first wavelength light and downconvert at least a first portion of the received light to an emitted second wavelength light. The projection system further includes a scanning optical element disposed to receive the emitted second wavelength light, and transmit the emitted second wavelength light along a scanned direction. The projection screen is disposed to intercept the scanned light.

In yet another aspect, the present disclosure provides a projection system that includes

an electroluminescent device emitting light at a first wavelength and a first array of receiving elements. The first array of receiving elements include at least one first semiconductor multilayer stack disposed to receive the emitted first wavelength light and downconvert at least a first portion of the received light to an emitted second wavelength light. The projection system further includes a scanning optical element disposed between the electroluminescent device and the first array. The scanning optical element is capable of sequentially directing the emitted first wavelength light from the electroluminescent device toward one of a plurality of receiving elements of the first array.

In yet another aspect, the present disclosure provides a display that includes a projection system and a projection screen. The projection system includes an electroluminescent device emitting light at a first wavelength and a first array of receiving elements. The first array of receiving elements include at least one first semiconductor multilayer stack disposed to receive the emitted first wavelength light and downconvert at least a first portion of the received light to an emitted second wavelength light. The projection system further includes a scanning optical element disposed between the electroluminescent device and the first array. The scanning optical element is capable of sequentially directing the emitted first wavelength light from the electroluminescent device toward one of a plurality of receiving elements of the first array. The projection screen is disposed to intercept the scanned light.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1 shows a schematic view of a projector system;

FIG. 2 shows a perspective view of a projection system;

FIG. 3 shows a perspective view of a projection system;

FIG. 4 shows a perspective view of a projection system;

FIG. 5 shows a perspective view of a projection system;

FIG. 6 shows a perspective view of a projection system;

FIGS. 7A-7B shows schematic views of a projection system;

FIGS. 8 shows a perspective view of a projection system;

FIGS. 9 shows a perspective view of a projection system;

FIG. 10 shows a perspective view of a projection system; and

FIG. 11 shows a perspective view of a projection system.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Projection systems have been described, for example, in Published PCT Patent Application No. WO2008/109296 entitled ARRAY OF LUMINESCENT ELEMENTS, and provides high resolution and brightness with low power and size. The projection system includes a monolithic two dimensional array of electroluminescent devices, some or all of the elements incorporating adjacent II-VI quantum well down-converters.

The present application describes projection systems, in particular microprojection systems that include an electroluminescent device or an array of electroluminescent devices, and an array of multilayer semiconducting stacks that are capable, in some embodiments, of down-converting, disposed to convert light emitted by the electroluminescent device(s) into a different wavelength spectrum of light. In one embodiment, a scanning optical element is used to direct light from the electroluminescent device(s) toward different portions of the array of downconverting elements. In another embodiment, a scanning optical element is used to direct light emitted by the array of downconverting elements into projection optics.

In one particular embodiment, the present application describes an alternative system that also includes II-VI quantum well down-converters to provide similar benefits in miniature projector applications. Generally, the present application describes an electronic display system that includes: a) a linear array of II-VI quantum well down-converters emitting visible light, b) a linear array of lasers or LEDs to optically pump the quantum wells, and c) a beam-deflecting device to scan the light beams from the linear array of emitters to provide a two-dimensional image. This two-dimensional image can be projected onto a screen, or it can be used in a near-to-eye display or other display applications.

Generation of visible light from optically pumped II-VI quantum well structures can have advantages over commercial semiconductor sources. The advantages include, for example, greater power efficiency in green, a more stable wavelength versus temperature for red, a more stable wavelength versus pump power for green, the ability to tune peak emission to any visible wavelength, and narrow emission bandwidth (particularly in the green).

Depending on the device structure and level of pumping, the output of the quantum wells can be laser-like (that is, collimated, coherent radiation), or superluminescent (that is, moderately collimated), or photoluminescent (that is, Lambertian, incoherent radiation). The full color image can originate in a single linear RGB array of pumps and down-converters, which may contain one element of each color for every row in the image, or a fraction of that number. Alternatively, there could be a separate linear array of pumps and down-converters for each primary color, with the beams combined optically to give a full color image on a screen.

In one particular embodiment, light sources that include an array of light emitting regions are also described. The light sources can efficiently output light at any wavelength in, for example, the visible region of the spectrum. The light sources can be designed to output, for example, one or more primary colors or white light. The light sources can be compact with reduced weight because, for example, the array of light emitting regions can be compactly integrated onto a substrate. The emission efficiency and compactness of the light sources can lead to new and improved optical systems, such as portable projection systems, having reduced weight, size and power consumption.

The light sources can have larger and smaller light emitting regions where the output light of each region can be actively and independently controlled. The light sources can be used in, for example, a projection system to illuminate one or more pixelated image forming devices. Each light emitting region of the light source can illuminate a different portion or zone of the image forming device. Such a capability allows for efficient adaptive illumination systems where the output light intensity of a light emitting region of the light source can be actively adjusted to provide the minimum illumination required by a corresponding zone in the image forming device.

The light sources can form monochromatic (for example, green or green on black) or color images. Such light sources combine the primary functions of light sources and image forming devices resulting in reduced size, power consumption, cost and the number of element or components used in an optical system that incorporates the disclosed light sources. For example, in a display system, the disclosed light sources can function as both the light source and the image forming device, thereby eliminating or reducing the need for a backlight or a spatial light modulator.

Arrays of luminescent elements, such as arrays of pixels in a display system, are disclosed in which at least some of the luminescent elements include an electroluminescent device, such as an LED, capable of emitting light in response to an electric signal. Some of the luminescent elements include one or more light converting elements, such as one or more potential wells and/or quantum wells, for downconverting light that is emitted by the electroluminescent devices. As used herein, downconverting means that the wavelength of the converted light is greater than the wavelength of the unconverted light.

Arrays of luminescent elements disclosed in this application can be used in illumination systems, such as adaptive illumination systems, for use in, for example, projection systems or other optical systems.

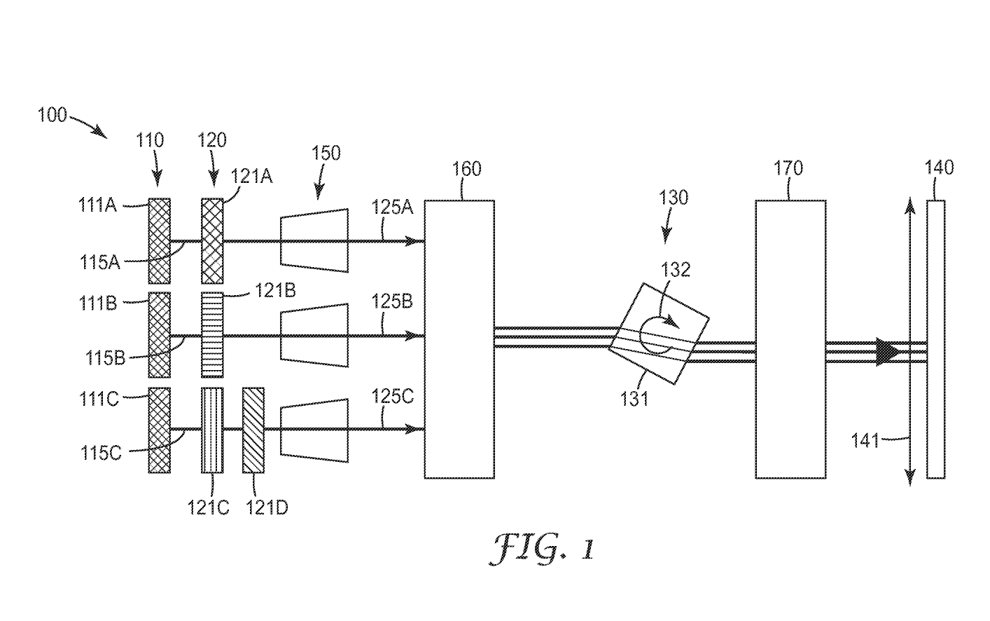

FIG. 1 shows a schematic view of a projector system 100 according to one aspect of the disclosure. Projector system 100 includes a first linear array 110 including electroluminescent devices emitting light at a first wavelength. First linear array 110 includes, for example, a first, a second and a third electroluminescent device 111A, 111B, and 111C capable of emitting a first, a second, and a third light 115A, 115B, and 115C, having a first wavelength, λ_{A}, λ_{B}, and λ_{C}, respectively. In some cases, each of the first wavlengths, λ_{A}, λ_{B}, and X_{C}, can be the same, for example a short wavelength light such as blue or ultraviolet. In some cases, each of the first wavelengths λ_{A}, λ_{B}, and λ_{C}, can be different wavelengths.

A second linear array 120 can be disposed to receive the emitted first wavelength light from the first linear array 110. FIG. 1 shows the second linear array 120 that includes, for example, light converting elements (LCE) such as a first, a second, and a third semiconductor multilayer stack 121A, 121B, and 121C. Each of the first, second, and third semiconductor multilayer stacks 121A, 121B, and 121C are capable of downconverting the emitted (and received) first wavelength light 115A, 115B, and 115C, to an emitted light having a second wavelength. For example, emitted first wavelength light 115A from first electroluminescent device 111A can be downconverted to emitted second wavelength light 125A by first semiconductor multilayer stack 121A.

In some cases, the emitted first wavelength light from one or more of the first, second, or third electroluminescent devices (111A, 111B, 111C) of the first linear array 110 is at a wavelength that does not need to be downconverted, for example, if a blue light is emitted from the electroluminescent device, and a blue light is desired as the final output. In such cases, the semiconductor multilayer stack can be omitted from the second array at that location.

In some cases, a first emitted light can be downconverted twice (or more), for example, as shown by third electroluminescent device 111C that emits third light 115C having a wavelength λ_{C}. Third light 115C can be downconverted once by third semiconductor multilayer stack 121C, and downconverted a second time by an optional fourth semiconductor multilayer stack 121D. For example, a blue wavelength light can be downconverted a first time to a green wavelength light, and the green wavelength light can be subsequently downconverted a second time to a red wavelength light. Such “double downconverting” may be useful in some cases to improve the efficiency of conversion from a blue wavelength light to a red wavelength light. In some cases, double downconversion does not require the use of two separate down-converter elements, but can instead take place in a single monolithic piece of converter material. In such cases, the single monolithic piece of converter material includes absorber layers absorbing both the blue pump and the green emission, and potential well layers emitting both green and red light.

Generally, the first linear array 110 (the “pump array”) and the second linear array 120 (the “downconverting array”) can be adhesively bonded or wafer bonded to each other, as described elsewhere. For the cases when the pump array is a linear laser diode array, it may either be separated from, or bonded to the downconverting array. In one particular embodiment, the pump array is separated from the downconverting array, and there may be an intermediate optical element that serves to deliver the pump light to the downconverter. Either one or both of the first linear array 110 and the second linear array 120 can be monolithic, that is, formed as a single structure that is inseparable.

Projector system 100 further includes an optional collimation optics 150, an optional relay optics 160, a scanning optical element 130, an optional projection optics 170 and an image plane 140. Optional collimation optics 150 can partially collimate light, for example, where the second emitted light 125A, 125B, 125C exits the pump/downconverter array with a Lambertian or near-Lambertian distribution. Optional collimation optics 150 can include, for example, lenses that can either be bonded directly to the second linear array 120 using the techniques described elsewhere, or can be formed as an integral part of the array as described, for example, in U.S. Application Ser. No. 61/114,237, entitled ELECTRICALLY PIXELATED LUMINESCENT DEVICE INCORPORATING OPTICAL ELEMENTS, filed on Nov. 13, 2008.

Optional relay optics 160 can include known mirrors, prism, lenses, etc., to direct second emitted light 125A, 125B, and 125C, to scanning optical element 130, where the emitted light is transmitted along a scanned direction 141. Scanning optical element 130 can include any well known 1-axis scanner including, for example, galvo mirrors, MEMS devices, or rotating mirrors or prisms, or the like. In some embodiments, a second “slow scan” perpendicular to the fast scan is also required, and can be accomplished by any well known system including, for example, 2-axis scanners including dual rotating mirrors, rotating mirrors with progressively tilted facets, or MEMS mirrors, or the like.

In some cases, the projector system 100 of FIG. 1 can instead be used in, for example, a near-to-eye display. In a near-to-eye display, the optional projection optics 170 and image plane 140 of FIG. 1 could be replaced by the viewer's eye and appropriate optics to transmit the scanned beams. As used herein, the discussion and examples may be described in terms of projection applications, but they are to be understood to also apply more broadly to other display applications as well.

The pump sources can be high resolution emissive devices including a “1×n” array of emitting regions, each of which is independently addressable using a digital or analog driving circuit, as known in the art. Linear arrays that emit short wavelength light in the visible (for example blue) or ultraviolet region of the electromagnetic spectrum can be especially desirable. There are at least two classes of linear emitter arrays that may be considered as candidates for microprojection systems, including light emitting diodes and laser diodes, both of which can be either edge emitting or surface emitting designs.

Linear microarrays of LEDs can be monolithic emissive devices fabricated on a single growth substrate and processed to allow for individual addressing of each element in the array. An LED electroluminescent device can emit light at any wavelength that may be desirable in an application. For example, the LED can emit light at a UV wavelength, a visible wavelength, or an IR wavelength. In some cases, the LED can be a short-wavelength LED capable of emitting UV photons. In general, the LED and/or a light converting element (LCE) may be composed of any suitable materials, such as organic semiconductors or inorganic semiconductors, including Group IV elements such as Si or Ge; III-V compounds such as InAs, AlAs, GaAs, InP, AlP, GaP, InSb, AlSb, GaSb, GaN, AN, InN and alloys of III-V compounds such as AlGaInP and AlGaInN; II-VI compounds such as ZnSe, CdSe, BeSe, MgSe, ZnTe, CdTe, BeTe, MgTe, ZnS, CdS, BeS, MgS and alloys of II-VI compounds such as CdMgZnSe, MgZnSeTe, BeCdMgZnSe, or other alloys of any of the compounds listed above.

In some cases, the LED can include one or more p-type and/or n-type semiconductor layers, one or more active layers that may include one or more potential and/or quantum wells, buffer layers, substrate layers, and superstrate layers.

In some cases, the LED and/or the LCE can include layers of CdMgZnSe alloys having compounds ZnSe, CdSe, and MgSe as the three constituents of the alloy. In some cases, one or more of Cd, Mg, and Zn, especially Mg, may have zero concentration in the alloy and therefore, may be absent from the alloy. For example, the LCE can include a Cd_{0.70}Zn_{0.30}Se quantum well capable of emitting in the red, or a Cd_{0.33}Zn_{0.67}Se quantum well capable of emitting in the green. As another example, the LED and/or the LCE can include an alloy of Cd, Zn, Se, and optionally Mg, in which case, the alloy system can be represented by Cd(Mg)ZnSe. As another example, the LED and/or the LCE can include an alloy of Cd, Mg, Se, and optionally Zn. In some cases, a quantum well LCE has a thickness in a range from about 1 nm to about 100 nm, or from about 2 nm to about 35 nm.

In some cases, a semiconductor LED or LCE may be n-doped or p-doped where the doping can be accomplished by any suitable method and by inclusion of any suitable dopant. In some cases, the LED and the LCE are from the same semiconductor group. In some cases, the LED and the LCE are from two different semiconductor groups. For example, in some cases, the LED is a III-V semiconductor device and the LCE is a II-VI semiconductor device. In some cases, the LEDs include AlGaInN semiconductor alloys and the LCEs include Cd(Mg)ZnSe semiconductor alloys.

An LCE can be disposed on or attached to a corresponding electroluminescent device by any suitable method such as by an adhesive such as a thermal cure or hot melt adhesive, welding, pressure, heat or any combinations of such methods. Examples of suitable thermal cure adhesives include silicone, acrylate, and polysilazane formulations. Examples of suitable hot melt adhesives include semicrystalline polyolefins, thermoplastic polyesters, and acrylic resins.

In some cases, an LCE can be attached to a corresponding electroluminescent device by a wafer bonding technique. For example, the uppermost surface of the electroluminescent device and the lowermost surface of the LCE can be coated with a thin layer of silica or other inorganic materials using, for example, a plasma assisted or conventional CVD process. Next, the coated surfaces can be optionally planarized and bonded using a combination of heat, pressure, water, or one or more chemical agents. The bonding can be improved by bombarding at least one of the coated surfaces with hydrogen atoms or by activating the surface using a low energy plasma. Wafer bonding methods are described in, for example, U.S. Pat. Nos. 5,915,193 and 6,563,133, and in chapters 4 and 10 of “Semiconductor Wafer Bonding” by Q.-Y. Tong and U. Gosele (John Wiley & Sons, New York, 1999).

In some cases, a quantum or potential well LCE can have one or more light absorbing layers proximate the well to assist in absorbing light emitted from a corresponding electroluminescent device. In some cases, the absorbing layers are composed of materials in which photogenerated carriers can efficiently diffuse to the potential well. In some cases, the light absorbing layers can include a semiconductor, such as an inorganic semiconductor. In some cases, a quantum or potential well LCE can include buffer layers, substrate layers, and superstrate layers.

An electroluminescent device or an LCE can be manufactured by any suitable method. For example, a semiconductor electroluminescent device and/or LCE can be manufactured using molecular beam epitaxy (MBE), chemical vapor deposition (CVD), liquid phase epitaxy (LPE) or vapor phase epitaxy (VPE).

LED microarrays based on wide band gap III-V semiconductor alloys, such as gallium nitride (GaN) can be particularly useful in the proposed system utilizing down-converters, since they efficiently emit light in the blue to violet region of the visible spectrum enabling photoluminescence from the down-converters in the red and green regions. Exemplary 64×64 microarrays of GaN LEDs have been fabricated, for example, by the Dawson group at Strathclyde University with a center-to-center pitch of 50 microns (Z. Gong, et al., “Matrix-Addressable Micropixellated InGaN Light-Emitting Diodes With Uniform Emission and Increased Light Output”, IEEE Electron Device Letters, 54 (10), 2007, 2650).

The pump array may also be based on coherent, collimated sources such as superluminescent light emitting diodes and lasers. Laser microarrays may be fabricated using at least three distinct laser technologies: edge-emitting solid state laser diodes (EESSLDs), vertical cavity surface-emitting lasers (VCSELs), and vertical extended cavity surface-emitting lasers (VECSELs). One example of the last technology is the NECSEL from Novalux, Sunnyvale, Calif.

In one particular embodiment, the projection systems described include a linear array of downconverting elements based on II-VI quantum well (QW) technology. II-VI QWs are layered semiconductor alloys comprising elements from both Group IIb and Group VI of the periodic table of elements, as described elsewhere.

Semiconductor group II-VI QWs exhibit several properties that can be beneficial in display applications, such as microprojection. For example, QWs can be constructed such that they emit light in a narrow spectral band, which is the characteristic of saturated color. Displays based on saturated primary colors (red, green, and blue, for example) have a larger color gamut than displays including less saturated primary colors. Also, for example, QWs have extremely short excited-state lifetimes on the order of nanoseconds. Short lifetimes allow for the use of pulse width modulation schemes to generate grayscale brightness values in scanned imaging systems with limited pixel residence time.

The emissive output of the linear array of quantum wells can be laser-like, for example, fairly well collimated, coherent radiation. The emissive output of the linear array of quantum wells can instead be superluminescent, for example, moderately collimated. The emissive output of the linear array can instead be photoluminescent, for example, Lambertian, incoherent radiation. The type of emission can be controlled by the device structure and level of pumping. Generally, optical elements can be disposed on the image emitter to direct more of its light onto the scanning device and through the projection optics. These optical elements, herein referred to as “collection optics” can be selected on the basis of the character of the emitted light and the optical system geometry, and might include periodic structures on the emissive face, frustum extractors, microlenses, graded index (GRIN) lenses, and the like. Exemplary collection optics are described, for example, in Published U.S. Patent Application No. 2005/041567 (Conner), and also in U.S. Pat. Nos. 7,300,177 (Conner); 7,070,301 (Magarill); 7,090,357 (Magarill et al.); 7,101,050 (Magarill et al.); 7,427,146 (Conner); 7,390,097 (Magarill); 7,246,923 (Conner); and 7,423,297 (Leatherdale et al.).

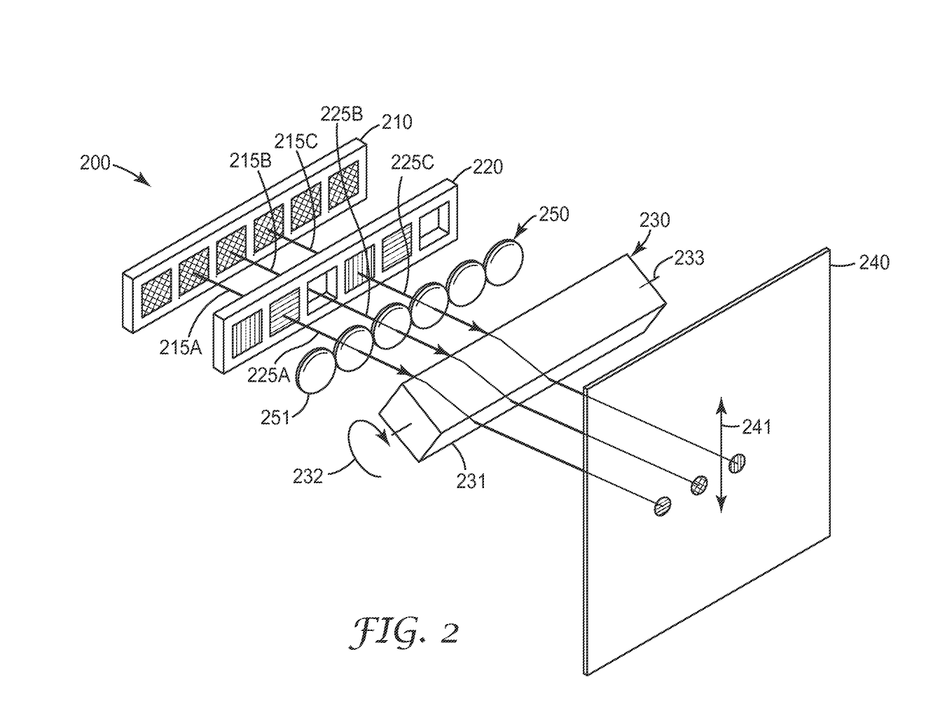

FIG. 2 shows a perspective view of a projection system 200 according to one particular aspect of the disclosure. Each of the elements 210-241 shown in FIG. 2 correspond to the description of like-numbered elements 110-141 shown in FIG. 1, which have been described previously. For example, the description of first linear array 110 in FIG. 1 corresponds to the description of first linear array 210 in FIG. 2, and so on. Projection system 200 includes a first monolithic linear array 210 of blue or ultraviolet LEDs monolithically aligned and bonded to a second monolithic linear array 220 of group II-VI quantum well photoluminescent emitters. In this embodiment, for example, emitted first blue light 215A becomes downconverted to emitted second green light 225A and emitted first blue light 215C becomes downconverted to emitted second red light 225C, after passing through second linear array 220. Emitted first blue light 215B passes unconverted through second linear array 220, becoming emitted second blue light 225B. In some cases, the emitted second blue light 225B can arise from downconversion of an ultraviolet pump light, or as shown in FIG. 2, second blue light 225B can be the LED light transmitted through an optical window.

Emitted second green, blue, and red lights (225A, 225B, 225C, respectively) pass through collimating lenses 251 in optional collimating optics array 250, and are scanned along a scanning direction 241 on image plane 240 by a scanning optical element 230. In FIG. 2, scanning optical element 230 is shown to be a rectangular prism 231 rotating about an axis 233 in the direction 232, although any suitable scanning optical element can be used, as described elsewhere.

A full color image of “m” columns by “n” rows can be generated on image plane 240 using a first and second linear array (210, 220) having “n” elements each of red, green and blue. Within the time period of a single image frame, each emitter in the first linear array 210 can be driven to sequentially output light corresponding to the “m” pixel values within its row. The 1-axis scanner then scans this linear light pattern through the aperture of a projection lens (not shown in FIG. 2, or in most subsequent figures) to provide a full two-dimensional image on the image plane.

A full color image of “m” columns by “n” rows can instead be generated by “swath scanning” on image plane 240 using a first and second linear array (210, 220) having fewer elements, for example, “n/k” elements each of red, green and blue. Within the time period of a single image frame, each emitter in the first linear array 210 is driven to sequentially output light corresponding to the “m” pixel values within its row. The 1-axis scanner then scans this linear light pattern through the aperture of a projection lens (not shown in FIG. 2, or in most subsequent figures) to provide a partial two-dimensional image on the image plane. In addition to this fast scan, there would also be a slow scan of k subframes within the overall image frame, so that the image would be written in swaths. This could be accomplished by a scanning polygon mirror of k facets, with each facet tilted slightly with respect to its neighbors, so that the overall image could be written.

A full color image of “m” columns by “n” rows can instead be generated by “interlaced scanning” on image plane 240 using a first and second linear array (210, 220) having fewer elements, for example, “n/k” elements each of red, green and blue. Within the time period of a single image frame, each emitter in the first linear array 210 is driven to sequentially output light corresponding to the “m” pixel values within its row. The t-axis scanner then scans this linear light pattern through the aperture of a projection lens (not shown in FIG. 2, or in most subsequent figures) to provide a partial two-dimensional image on the image plane. In addition to this fast scan, there would also be a slow scan of k subframes within the overall image frame, so that the image would be written with gaps between the emitted beams. This could be accomplished by a scanning polygon mirror having a facet-to-facet tilt on the polygon smaller than in the “swath scanning” described previously, so that the overall image would be written in interlaced fashion. For an interlace factor of k, the linear emitter would need somewhat more than 3n/k elements, to insure that all 3 colors are written into each of the n rows.

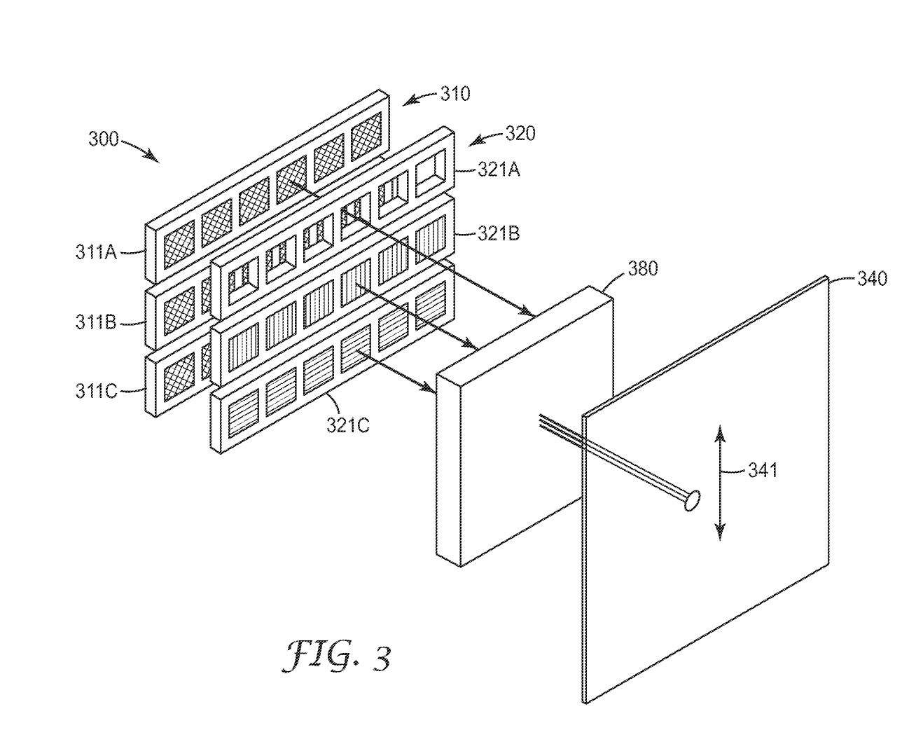

FIG. 3 shows a perspective view of a projection system 300 according to one particular aspect of the disclosure. Each of the elements 310-341 shown in FIG. 3 correspond to the description of like-numbered elements 210-241 shown in FIG. 2, which have been described previously. For example, the description of first linear array 210 in FIG. 2 corresponds to the description of collective first linear array 310 in FIG. 3, and so on.

Projection system 300 includes three separate first linear arrays 311A, 311B, and 311C, of collective first linear array 310 for each of the colors. In one embodiment shown in FIG. 3, blue can be generated from a first linear array 311A including GaN blue LEDs, and second linear array 321A can be an array of optical windows. In another embodiment, blue can be generated from a first linear array 311A including GaN ultraviolet LEDs with integral group II-VI down-converters in second linear array 321A.

Green can be generated from a first linear array 311B including GaN green LEDs, and second linear array 321B can be an array of optical windows. In another embodiment, green can be generated from a first linear array 311B including GaN blue or ultraviolet LEDs, with integral group II-VI down-converters 321B. Red can be generated from a first linear array 311C including AlGaInP red LEDs, and second linear array 321C can be an array of optical windows. In another embodiment, red can be generated from a first linear array 311C including GaN blue or ultraviolet LEDs with integral II-VI down-converters 321C. Each array can have collection optics 380, as described elsewhere, to bring the output to a common 1-axis scanning optical element and into the projection lens aperture (not shown).

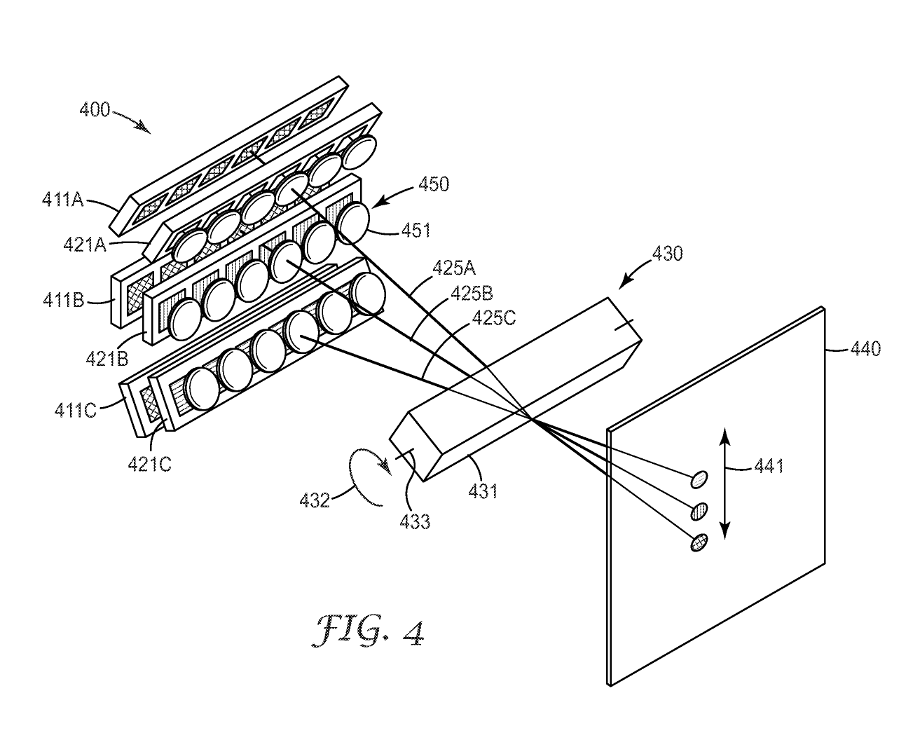

FIG. 4 shows a perspective view of a projection system 400 according to one particular aspect of the disclosure. Each of the elements 410-441 shown in FIG. 4 correspond to the description of like-numbered elements 310-341 shown in FIG. 3, which have been described previously. For example, the description of collective first linear array 310 in FIG. 3 corresponds to the description of collective first linear array 410 in FIG. 4, and so on.

As shown in FIG. 4, the three first linear arrays 411A, 411B, 411C, and the integral second linear arrays 421A, 421B, 421C, are disposed to impinge onto the scanning optical element 430 at slightly different angles. In this particular embodiment, the images can be electronically advanced or retarded in time, so that the colors are in register on the image plane 440.

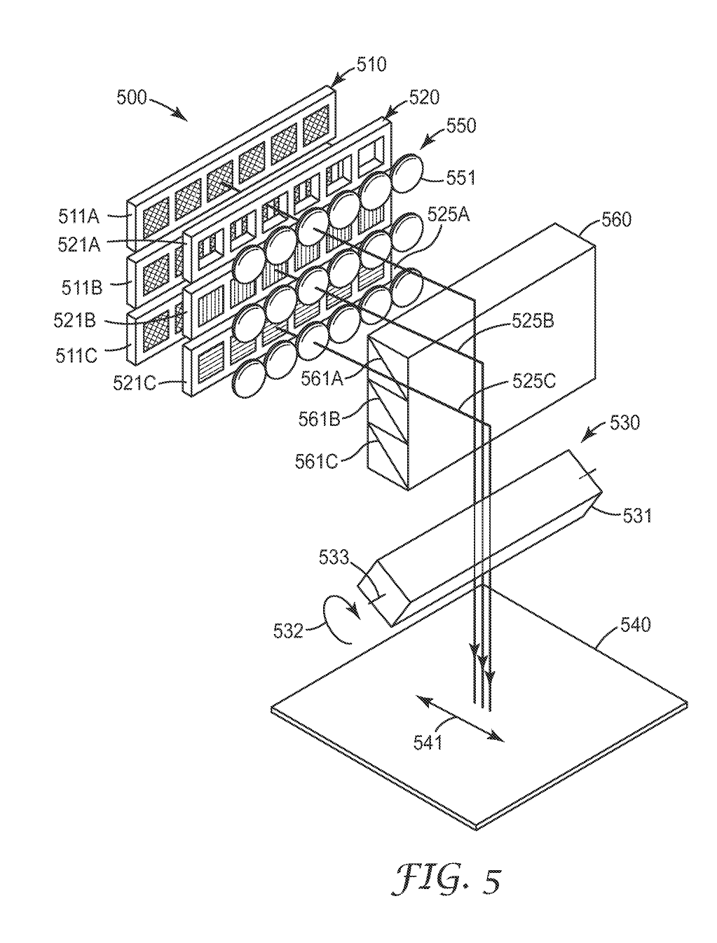

FIG. 5 shows a perspective view of a projection system 500 according to one particular aspect of the disclosure. Each of the elements 510-541 shown in FIG. 5 correspond to the description of like-numbered elements 410-441 shown in FIG. 4, which have been described previously. For example, the description of collective first linear array 410 in FIG. 4 corresponds to the description of collective first linear array 510 in FIG. 5, and so on.

As shown in FIG. 5, the three first linear arrays 511A, 511B, 511C, and the integral second linear arrays 521A, 521B, 521C, are each disposed to impinge onto a separate dichroic mirror (561A, 561B, 561C) in re-directing optical element 560. In FIG. 5, each of the dichroic mirrors (561A, 561B, 561C) are disposed so that light can impinge on the scanning optical element 530 at essentially the same angle.

Each of the embodiments shown in FIGS. 2-5 can instead use a first linear array of semiconductor lasers, such as an array of edge-emitting GaN blue or ultraviolet laser diodes, as the first linear array of electroluminescent devices, as described elsewhere. Better heat management can be provided by separation of the laser diode pump arrays from the group II-VI quantum well arrays. In addition, optional collimation optics can be used to focus each laser pump beam onto its respective group II-VI element.

For embodiments where the pump is chosen to be a blue laser diode array, there may be an additional consideration. Blue output through the windows in the group II-VI layer may be well collimated, unlike the red and green output from the group II-VI down-converters. If necessary, collection optics could be fashioned to accommodate this difference, or alternatively, a diffuser can be disposed in the blue window in the group II-VI quantum well layer.

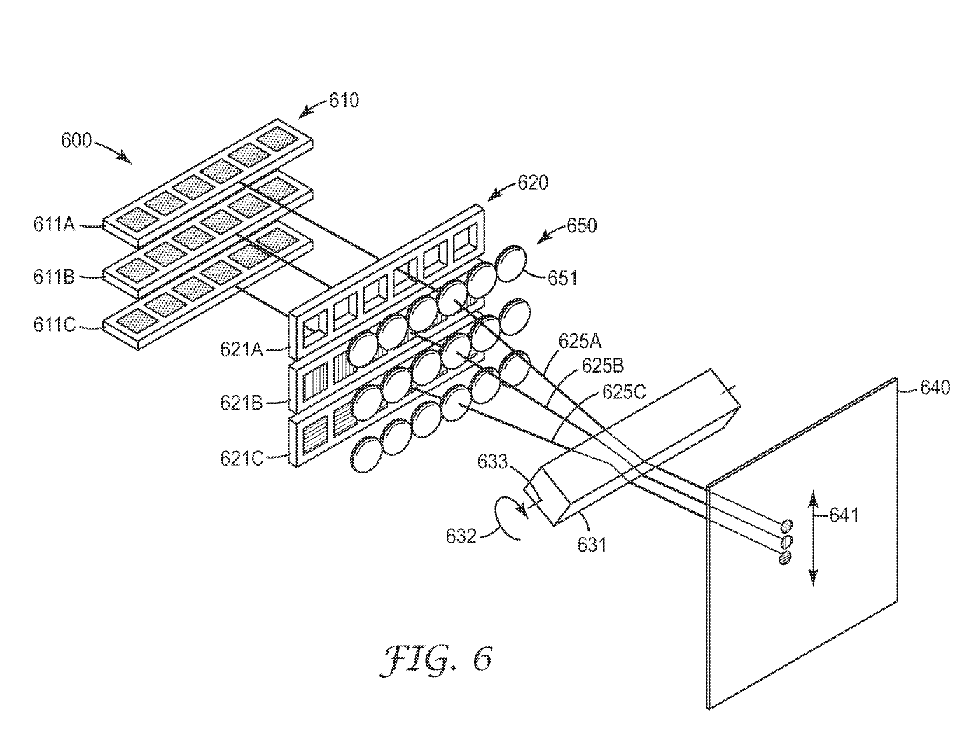

FIG. 6 shows a perspective view of a projection system 600, according to one particular aspect of the disclosure, where edge emitting semiconductor lasers are substituted for the electroluminescent devices as described in, for example, FIG. 3. In FIG. 6, projection system 600 includes three separate first linear arrays 611A, 611B, 611C of emitters 610. In this particular embodiment, each of the first linear arrays 611A, 611B, 611C are linear edge emitting laser arrays. Each of the other elements 620-641 shown in FIG. 6 correspond to the description of like-numbered elements 220-241 shown in FIG. 2, which have been described previously. For example, the description of second linear array 220 in FIG. 2 corresponds to the description of second linear array 620 in FIG. 6, and so on.

In some embodiments, such as, for example, edge-emitting GaN green or AlGaInP red laser diodes, the first linear arrays 611A-611C may not require II-VI down-converters, as described elsewhere, in second linear arrays 621A-621C. For those well collimated colors, the collection optics before the scanner might be simplified or eliminated. Also, with well collimated emission, combination of the three colors within dichroic mirrors may be easier.

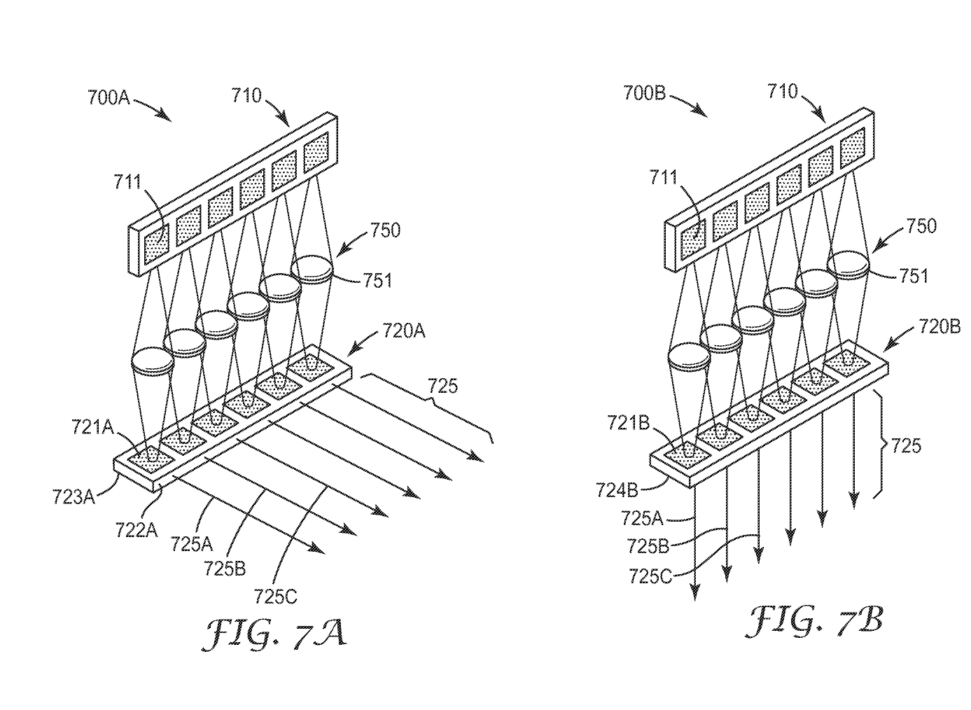

FIG. 7A and FIG. 7B show a schematic view of a projection system 700A and 700B, respectively, according to one particular aspect of the disclosure. In FIGS. 7A-7B, edge emitting semiconductor lasers are substituted for the electroluminescent devices as described in, for example, FIG. 4 and FIG. 5. In FIGS. 7A-7B, projection system 700A-700B includes a single first linear array 710 of edge emitting UV laser diodes 711.

In FIG. 7A, second linear array 720A includes down-converters 721A that can be, for example, II-VI quantum well superluminescent or laser edge emitters. Also in FIG. 7A, second linear array 720A includes a back surface reflector 723A, and one of a semitransparent or an antireflection front surface 722A.

In FIG. 7B, the second linear array 720B includes down-converters 721B that can be, for example, vertical-cavity II-VI quantum well superluminescent emitters. Also in FIG. 7B, the second linear array 720B includes a dichroic back surface 724B capable of passing UV light and reflecting visible light.

In the embodiments shown in FIG. 7A and FIG. 7B, the output of the II-VI quantum well layer is a parallel linear array 725 including, for example, a red beam 725A, a green beam 725B, and a blue beam 725C. Each of the red, green, and blue beams (725A, 725B, 725C) can be either laser light, or superluminescent light. Because the II-VI emission is now better collimated, versus the Lambertian emission from photoluminescent II-VI structures, the collection optics may be simpler and/or more effective.

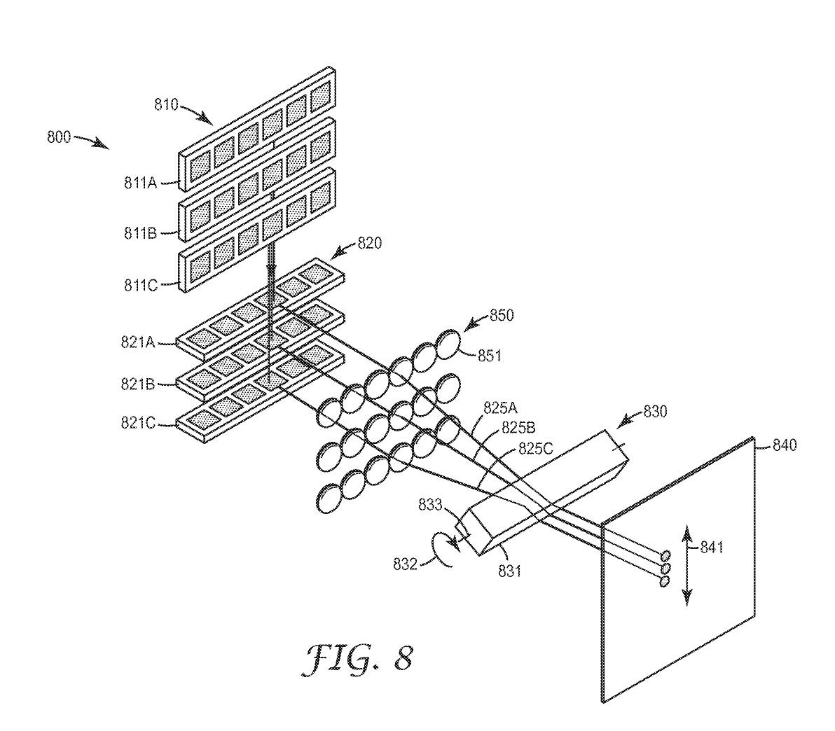

FIG. 8 shows a perspective view of a projection system 800, according to one particular aspect of the disclosure, where edge emitting semiconductor lasers are substituted for the electroluminescent devices as described in, for example, FIG. 5. In FIG. 8, projection system 800 includes three separate first linear arrays 811A, 811B, 811C of emitters 810. In this particular embodiment, each of the first linear arrays 811A, 811B, 811C are linear edge emitting laser arrays.

Projection system 800 further includes a downconverter array 820 that includes three separate second linear arrays 821A, 821B, 821C, that can be, for example, II-VI quantum well superluminescent or laser edge emitters. Each of the three separate second linear arrays 821A, 821B, 821C includes a back surface reflector 723A, and one of a semitransparent or an antireflection front surface 722A, similar to the second linear array 720A described in FIG. 7A. Each of the other elements 825-851 shown in FIG. 8 correspond to the description of like-numbered elements 625-651 shown in FIG. 6, which have been described previously. For example, the description of scanning optical element 630 in FIG. 6 corresponds to the description of scanning optical element 830 in FIG. 8, and so on.

In FIG. 8, appropriate optics (not shown) may be needed to most efficiently focus the pump beams to the II-VI layers, as described elsewhere. In another particular embodiment, superluminescent emission from the face of the II-VI layers, as shown, for example, in FIG. 7B can be substituted into FIG. 8, except that the beams from a single II-VI array would be a single color (as would readily be understood by one skilled in the art).

In some embodiments, the three single color linear arrays can include vertical cavity surface emitting lasers (VCSELs), as shown, for example, in U.S. Patent Application Ser. No. 61/094,270, entitled DIODE-PUMPED LASER SOURCE and filed on Sep. 4, 2008. The II-VI quantum wells can be fabricated with surrounding distributed Bragg reflectors (DBR) to form VCSEL laser cavities that can be optically pumped by a suitable shorter wavelength laser. The linear II-VI VCSEL array may be pumped from the rear by a uv laser diode array, or from the front. These embodiments would also yield a linear array of laser output, as does the edge-emitting II-VI laser case as shown, for example, in FIG. 7B. In this particular embodiment, the laser light is emitted from the tabular faces of the II-VI layers, instead of the edges.

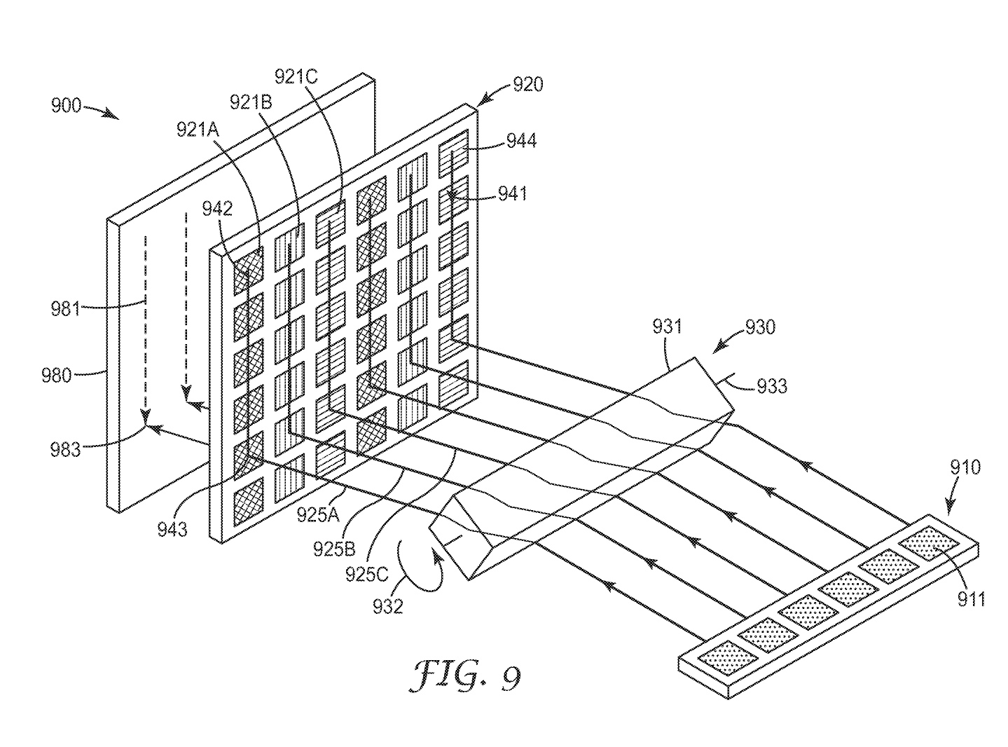

FIG. 9 shows a perspective view of a projection system 900 according to one particular aspect of the disclosure. In FIG. 9, the projection system 900 includes a scanning optical element 930 disposed between a first linear array 910 and a two dimensional array 920. Each of the other elements 930-941 shown in FIG. 9 correspond to the description of like-numbered elements 530-541 shown in FIG. 5, which have been described previously. For example, the description of scanning optical element 530 in FIG. 5 corresponds to the description of scanning optical element 930 in FIG. 9, and so on.

In FIG. 9, the projection system 900 includes a first linear array 910 that includes electroluminescent emitters 911. Each of the electroluminescent emitters 911 can be part of an array of ultraviolet lasers (for example, edge-emitting laser diodes) that can excite multiple pixels of a two dimensional array 920 simultaneously. For a given m×n image matrix and an array of “k” independently modulated lasers, the duty cycle for the average pixel rises to as much as k/(m×n). This can help enable sufficient image brightness and pixel count for a projected image, As shown in FIG. 9, each of the electroluminescent emitters 911 in the first linear array 910 are independently modulated for down-column scans (for example, a first pixel 942 to a scanned end pixel 943), and all are modulated simultaneously for across-row scans (for example, the first pixel 942 to a second end pixel 944).

A first, a second and a third light beam 925A, 925B, and 922C from first linear array 910 pass through scanning optical element 930 to optically pump a first, a second, and a third semiconductor multilayer stack 921A, 921B, and 921C arranged in two dimensional array 920. As seen in FIG. 9, scanning optical element 930 can be a rectangular prism 931 rotating in direction 932 around axis 933 to scan each of the first, the second and the third light beam 925A, 925B, and 922C along a scanning direction 941. As each one of the light beams scans down the two-dimensional array 920, for example, the first semiconductor multilayer stack, 921, is pumped sequentially from the first pixel 942 to the end pixel 943, and the downconverted light is projected onto screen 980 as projected downconverted light scanned along path 981.

In one embodiment shown in FIG. 9, each laser diode in the array addresses one line of only a single color; however, FIG. 9 is not limited to that case. For example, first linear array 910 and scanning optical element 930 could be rotated 90° with respect to two dimensional array 920, so that each laser diode excites a series of colors. Also, the pixels 921A, 921B, 921C, can be square shaped, rectangular shaped, triangular shaped, or, for example, hexagonal shaped and still be addressed by the linear laser array.

Scanning of this linear array could be accomplished by well known 1-axis scanners such as the rotating prism shown in FIG. 9, or rotating mirrors, or resonant galvos, or MEMS mirrors, as described elsewhere. It may be preferred in some embodiments, that the number of electroluminescent devices 911 be comparable to either the number of rows or columns of the two dimensional array 920, that is, that there is a modulatable element in the laser array for each row (column) of the display, and the motion of the laser spots is purely across the columns (rows) of the display.

It is to be understood that the projected downconverted light scanned along, for example, path 981, can be projected onto a screen 980, or it can be used in a near-to-eye display or other display applications (not shown). The electroluminescent emitters 911 can include edge emitting laser diodes, VCSELs, or other LEDs including superluminescent, photonic lattice, and the like, that can be sufficiently collimated and scanned as pumps.

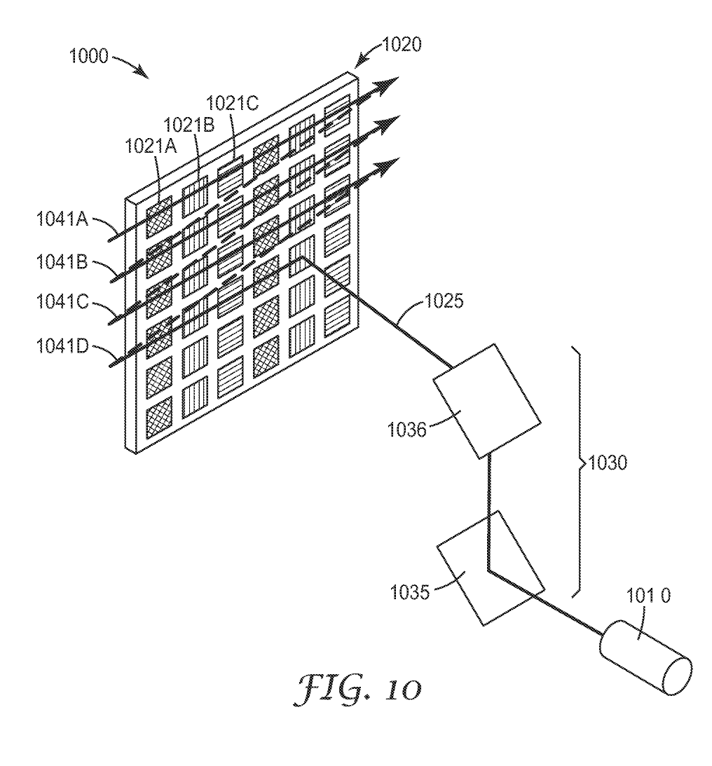

FIG. 10 shows a perspective view of a projection system 1000 according to one particular aspect of the disclosure. In FIG. 10, the projection system 1000 includes a scanning optical element 1030 disposed between a first electroluminescent device 1010 and a two dimensional array 1020. Scanning optical element 1030 can be a controlled scanning in two axes, using, for example, well-known devices such as resonant galvos, MEMS mirrors, or two polygon mirrors rotating in orthogonal directions. The laser light intensity is modulated, either directly or with a separate acousto-optic modulator, synchronously with the colors/pixels being pumped. Each of the other elements 1020-1041 shown in FIG. 10 correspond to the description of like-numbered elements 920-941 shown in FIG. 9, which have been described previously. For example, the description of two dimensional array 920 in FIG. 9 corresponds to the description of two dimensional array 1020 in FIG. 10, and so on.

In one particular embodiment, the first electroluminescent device 1010 is a single ultraviolet laser that pumps the two dimensional array 1020 of RGB quantum well elements (1021A, 1021B, 1021C). Light beam 1025 is sequentially scanned across two dimensional array 1020 using scanning optical element 1030 that includes, for example, a first galvo mirror 1035 and a second galvo mirror 1036. Sequential scanning is shown by, for example, a first through fourth scanning directions 1041A-1041D.

In the embodiment shown in FIG. 10, the laser power density at the quantum well down-converters may need to be limited, to remain below the damage threshold of the materials forming the quantum wells. However, for a single laser exciting the entire “m×n” (row×column) matrix of quantum well pixels (with m≧n) in time sequence, the duty cycle for the average pixel can be no better than 1/m×n. Also, refresh rates of less than 30 frames per second (fps) could lead to objectionable flicker to a viewer, and many applications can prefer 60 fps or much higher. There are also limits to how fast the laser can be modulated, either directly or indirectly. The combination of duty cycle, maximum laser modulation rates, minimum frame refresh rates and damage threshold limitations can limit the image brightness or pixel count of the II-VI display, and may mean that this embodiment is more suitable for applications such as near-to-eye, but less suitable for applications requiring more emissive output, such as projection.

In some cases, it may be preferable for the pump source and the projection optics to be on opposite sides of the quantum well structure. In such cases, it can be desirable to have a dichroic mirror or a DBR that passes UV and reflects visible light on the input side of the quantum well array, as described elsewhere. In other cases, it can be desirable to have a dichroic mirror that passes blue and reflects red and green light on the input side of the quantum well array.

In some cases, it may be preferable for the pump source and the projection optics to be on the same side of the quantum well structure. In such cases, it can be desirable to have a metallic reflector on the side of the quantum well array, away from the pump and projection optics, for heat management and to increase light directed toward the projection optics.

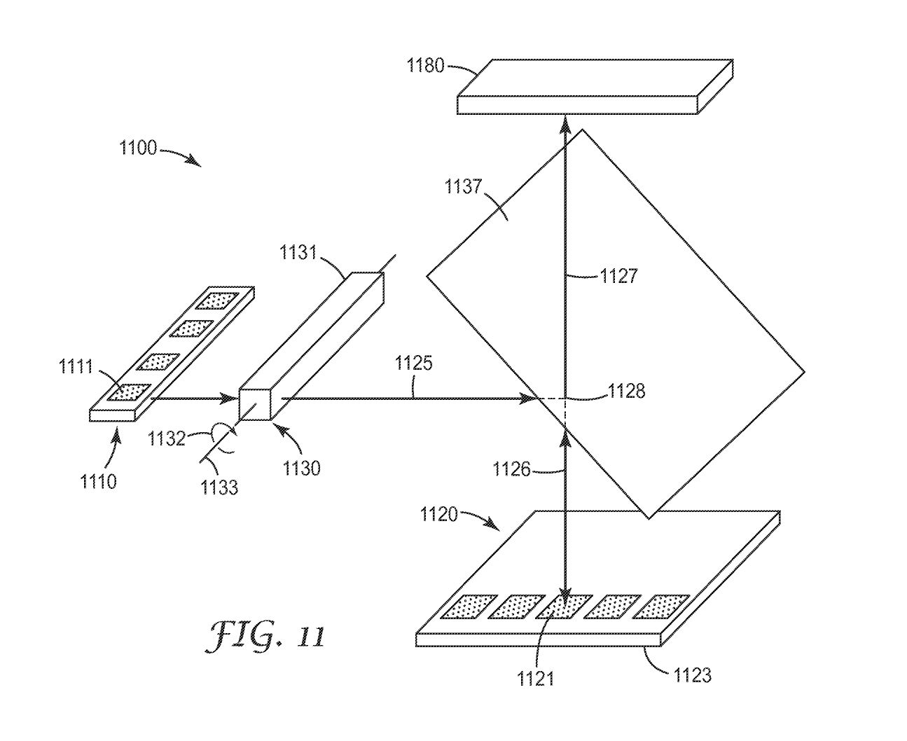

FIG. 11 shows a perspective view of a projection system 1100, according to one particular aspect of the disclosure. In FIG. 11, projection system 1100 includes a scanning optical element 1130 disposed between a first linear array 1110 that includes electroluminescent emitters 1111, and a two dimensional array 1120. Projection system 1100 further includes a dichroic mirror 1137 disposed between the first linear array 1110 and the two dimensional array 1120. In one particular embodiment, the dichroic mirror 1137 is reflective to ultraviolet (UV) light, and transmits other wavelengths of light.

Each of the electroluminescent emitters 1111 can be part of an array of ultraviolet lasers (for example, edge-emitting laser diodes, as depicted in FIG. 11) that can excite multiple pixels of a two dimensional array 1120 simultaneously. Each of the other elements 1110-1180 shown in FIG. 11 correspond to the description of like-numbered elements 910-980 shown in FIG. 9, which have been described previously. For example, the description of scanning optical element 930 in FIG. 9 corresponds to the description of scanning optical element 1130 in FIG. 11, and so on.

In FIG. 11, a light beam 1125 emitted from electroluminescent emitter 1111 passes through scanning prism 1130, and intersects the dichroic mirror 1137 at an intersection position 1128. In one particular embodiment shown, the dichroic mirror 1137 is at an approximately 45 degree angle to the light beam 1125. The light beam 1125 can be a UV light that reflects from dichroic mirror 1137 and is directed along a reflection path 1126 toward first semiconductor multilayer stack 1121 in two dimensional array 1120. Semiconductor multilayer stack 1121 can have a reflective back surface 1123, which can direct downconverted second light beam 1127 back along reflection path 1126, through dichroic mirror 1137, and onto projection screen 1180. The entire two dimensional array 1120 of semiconductor multilayer stacks 1121 can be scanned in a manner similar to that shown in FIGS. 9 and 10, as would be realized by one of ordinary skill in the art.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A projection system, comprising:
at least one first linear array including electroluminescent devices emitting light at a first wavelength;
a second linear array including at least one first semiconductor multilayer stack disposed to receive the emitted first wavelength light and downconvert at least a first portion of the received light to an emitted second wavelength light; and
a scanning optical element disposed to transmit at least the emitted second wavelength light along a scanned direction.

2. The projection system of claim 1, wherein the second linear array further comprises at least one second semiconductor multilayer stack disposed to receive the emitted first wavelength light and downconvert at least a second portion of the received light to an emitted third wavelength light.

3. The projection system of claim 1, further comprising a third linear array including at least one third semiconductor multilayer stack disposed to receive the emitted second wavelength light and downconvert at least a third portion of the received light to an emitted fourth wavelength light.

4. The projection system of claim 1, further comprising a fourth linear array including at least one fourth semiconductor multilayer stack disposed to receive the emitted first wavelength light and downconvert at least a fourth portion of the received light to an emitted fifth wavelength light.

5. The projection system of claim 1, further comprising a fifth linear array including collimation optical elements disposed to collimate at least the emitted second wavelength light.

6. The projection system of claim 1, wherein at least one of the first linear array and the second linear array are monolithic.

7. The projection system of claim 1, further comprising an optical cavity around the at least one first semiconductor multilayer stack.

8. The projection system of claim 7, wherein the optical cavity comprises Bragg reflectors.

9. A projection system, comprising:
a first linear array including electroluminescent devices emitting light at a first wavelength;
a second array of receiving elements including at least one first semiconductor multilayer stack, each of the first semiconductor multilayer stacks disposed to receive the emitted first wavelength light and downconvert at least a first portion of the received light to an emitted second wavelength light; and
a scanning optical element disposed between the first linear array and the second array, the scanning optical element capable of sequentially directing the emitted first wavelength light from each of the electroluminescent devices toward one of a plurality of receiving elements of the second array.

10. The projection system of claim 9, wherein the second array of receiving elements further comprises at least one second semiconductor multilayer stack disposed to receive the emitted first wavelength light and downconvert at least a second portion of the received light to an emitted third wavelength light.

11. The projection system of claim 9, further comprising a third array of receiving elements including at least one third semiconductor multilayer stack disposed to receive the emitted second wavelength light and downconvert at least a third portion of the received light to an emitted fourth wavelength light.

12-17. (canceled)

18. A projection system, comprising:
an electroluminescent device emitting light at a first wavelength;
a semiconductor multilayer stack disposed to receive the emitted first wavelength light and downconvert at least a first portion of the received light to an emitted second wavelength light; and
a scanning optical element disposed to receive the emitted second wavelength light, and transmit the emitted second wavelength light along a scanned direction.

19. The projection system of claim 18, further comprising a collimation optical element disposed to collimate the emitted second wavelength light.

20-22. (canceled)

23. A projection system, comprising:
an electroluminescent device emitting light at a first wavelength;
a first array of receiving elements comprising at least one first semiconductor multilayer stack disposed to receive the emitted first wavelength light and downconvert at least a first portion of the received light to an emitted second wavelength light; and
a scanning optical element disposed between the electroluminescent device and the first array, the scanning optical element capable of sequentially directing the emitted first wavelength light from the electroluminescent device toward one of a plurality of receiving elements of the first array.

24. The projection system of claim 23, wherein the first array of receiving elements further comprises at least one second semiconductor multilayer stack disposed to receive the emitted first wavelength light and downconvert at least a second portion of the received light to an emitted third wavelength light.

25. The projection system of claim 23, further comprising a second array of receiving elements including at least one third semiconductor multilayer stack disposed to receive the emitted second wavelength light and downconvert at least a third portion of the received light to an emitted fourth wavelength light.

26. The projection system of claim 23, further comprising a third array of receiving elements including at least one fourth semiconductor multilayer stack disposed to receive the emitted first wavelength light and downconvert at least a fourth portion of the received light to an emitted fourth wavelength light.

27. The projection system of claim 23, further comprising a collimation optical element disposed between the electroluminescent device and the scanning optical element, to collimate the emitted first wavelength light.

28. The projection system of claim 26, wherein at least one of the first array, the second array, and the third array are monolithic.

29. The projection system of claim 23, further comprising an optical cavity around the at least one first semiconductor multilayer stack.

30. The projection system of claim 29, wherein the optical cavity comprises Bragg reflectors.

31-42. (canceled)
